(19) United States
(12) Patent Application Publication
(10) Pub. No.: US 2016/0144767 A1
(43) Pub. Date: May 26, 2016

(54) VERTICALLY-ADJUSTABLE BED AND CLOSET FOR A RECREATIONAL VEHICLE

(71) Applicant: REV Recreation Group, Inc., Decatur, IN (US)

(72) Inventor: Mike Snell, Eugene, OR (US)

(21) Appl. No.: 14/951,022

(22) Filed: Nov. 24, 2015

Related U.S. Application Data
(60) Provisional application No. 62/084,694, filed on Nov. 26, 2014.

(51) Int. Cl. B60P 3/34; A47C 17/52

(52) U.S. Cl. CPC B60P 3/34; A47C 17/52

(57) ABSTRACT

An adjustable bed assembly for a vehicle. The bed assembly comprises a base platform including a head portion and a foot portion, with the base platform being configured to support a bed mattress. The bed assembly further comprises a storage housing positioned underneath the head portion of the base platform and presenting a storage space within the storage housing. The base platform and the storage housing are coupled together, so as to actuate in unison between a raised configuration and a lowered configuration.

### RELATED APPLICATION

This non-provisional patent application claims priority to U.S. Provisional Patent Application Ser. No. 62/084,694, filed on Nov. 26, 2014, and entitled “VERTICALLY-ADJUSTABLE BED AND CLOSET FOR A RECREATIONAL VEHICLE,” the entire disclosure of which is incorporated by reference into this non-provisional patent application.

### FIELD

Embodiments of the present invention are directed to a vertically-adjustable bed and closet for a vehicle. In more detail, embodiments of the present invention are directed to a vertically-adjustable bed and closet combination for a recreational-type vehicle, such as a motorhome.

### BACKGROUND

Recreational vehicles, such as campers, caravans, travel trailers, motor homes, or the like, while being relatively large compared to an average vehicle, generally offer quite confined living spaces. As such, there is normally a tradeoff between the amenities offered in a recreational vehicle and the vehicle's available living space. Given that most owners of recreational vehicles expect for their recreational vehicle to include certain amenities (e.g., kitchen amenities, entertainment amenities, bathroom amenities, bedroom amenities), it can be difficult to design a recreational vehicle that offers such amenities while providing a sufficient amount of living space for the owners and/or occupants.

Often, furniture and storage components of a recreational vehicle occupy a large portion of the available space within a recreational vehicle, such that the living space within the vehicle is reduced by such furniture and storage components. While storage components are generally a necessary amenity in a recreational vehicle, there is a need to balance the available space of the vehicle between storage components and the living space. Some previously-manufactured recreational vehicles offered various furniture and storage combinations that attempted to increase both the storage space and the living space within the vehicles. For example, certain bed designs include storage drawers integrated within a base of the bed, such that the base area of the bed can be used to support the bed and to store clothing. Nevertheless, such previously-manufactured recreational vehicles are still deficient in maximizing the storage space and living space in the vehicles.

Therefore, there exists a need for a recreational vehicle that provides enhanced living space and storage space efficiencies.

### SUMMARY

An embodiment of the present invention may include an adjustable bed assembly for a vehicle. The bed assembly comprises a base platform including a head portion and a foot portion, with the base platform being configured to support a bed mattress. The bed assembly further comprises a storage housing positioned underneath the head portion of the base platform and presenting a storage space within the storage housing. The base platform and the storage housing are coupled together, so as to actuate in unison between a raised configuration and a lowered configuration.

An additional embodiment of the present invention includes a vehicle with an adjustable bed assembly. The vehicle comprises a vehicle body enclosing a living space within the vehicle. The vehicle additionally includes the adjustable bed assembly, with the adjustable bed assembly comprising a base platform that includes a head portion and a foot portion, with the base platform configured to support a bed mattress. The adjustable bed assembly additionally includes a storage housing positioned underneath the head portion of the base platform and presenting a storage space within the storage housing. The base platform and the storage housing are coupled together, so as to actuate in unison between a raised configuration and a lowered configuration. The vehicle further includes first and second side components spaced apart to define a headspace area, with the headspace area being bounded by a ceiling of the vehicle. The head portion of the base platform is received within the headspace area. The vehicle further includes a storage housing receiving area located generally below the headspace area, with at least a portion of the storage housing receiving area is positioned below a floor of the vehicle. In the raised configuration, the base platform and the storage housing are positioned within the headspace area of the vehicle, such that the storage space is accessible from the living space of the vehicle. In the lowered configuration, the storage housing is received in the storage housing receiving area, such that the storage space is not accessible from the living space of the vehicle.

Another embodiment of the present invention may include a method of operating an adjustable bed assembly for a vehicle. The bed assembly may comprise base platform configured to support a bed mattress and a storage housing coupled with the base platform and positioned underneath the base platform, with the storage housing presenting a storage space within the storage housing. The method may comprise the initial step of shifting the bed assembly from a lowered configuration to a raised configuration. In the raised configuration, the base platform is positioned adjacent to a ceiling of the vehicle and the storage space is accessible from an interior of the vehicle. The method may include the additional step of actuating the bed assembly from the raised configuration to the lowered configuration. In the lowered configuration, the base platform is positioned adjacent to a floor of the vehicle and the storage space is not accessible from the interior of the vehicle. The base platform and the storage housing are configured to actuate in unison.

This summary is not intended to identify essential features of the present invention, and is not intended to be used to limit the scope of the claims. These and other aspects of the present invention are described below in greater detail.

### DRAWINGS

Embodiments of the present invention are described in detail below with reference to the attached drawing figures, wherein:

FIG. 1 is partial perspective view of a back end portion of a vehicle, with a portion of a body of the vehicle removed to show an adjustable bed assembly according to embodiments of the present invention located within an interior of the vehicle, with the adjustable bed assembly shown in a lowered configuration;

FIG. 2 is partial perspective view of the back end portion of the vehicle from FIG. 1, with the adjustable bed assembly shown in a raised configuration;

FIG. 3 is a perspective view of the vehicle from FIGS. 1 and 2 shown in its entirety and in dotted line, with the adjustable bed assembly shown in solid line;

FIG. 4 is perspective view of the adjustable bed assembly from FIGS. 1-2;

FIG. 5 is a side view of a longitudinal cross-section of the back end portion of the vehicle from FIGS. 1-2, with the adjustable bed assembly in the lowered configuration;

FIG. 6 is an additional side view of the longitudinal cross-section of FIG. 5, with the adjustable bed assembly in the raised configuration;

FIG. 7 is a front view of a lateral cross-section of the back end portion of the vehicle from FIGS. 1-2, with the adjustable bed assembly in the raised configuration;

FIG. 8 is an additional front view of the lateral cross-section of FIG. 7, with the adjustable bed assembly in the lowered configuration;

FIG. 9 is a partial perspective view of an exterior of a back end of the vehicle from FIGS. 1-3;

FIG. 10 is a schematic view of a hydraulic system for raising and lowering an adjustable bed assembly for a vehicle according to embodiments of the present invention; and

FIG. 11 is a schematic view of an electromechanical system for raising and lowering an adjustable bed assembly for a vehicle according to embodiments of the present invention.

The figures are not intended to limit the present invention to the specific embodiments they depict. The drawings are not necessarily to scale.

### DETAILED DESCRIPTION

The following detailed description of embodiments of the invention references the accompanying figures. The embodiments are intended to describe aspects of the invention in sufficient detail to enable those with ordinary skill in the art to practice the invention. Other embodiments may be utilized and changes may be made without departing from the scope of the claims. The following description is, therefore, not limiting. The scope of the present invention is defined only by the appended claims, along with the full scope of equivalents to which such claims are entitled.

In this description, references to “one embodiment”, “an embodiment”, or “embodiments” mean that the feature or features referred to are included in at least one embodiment of the invention. Separate references to “one embodiment”, “an embodiment”, or “embodiments” in this description do not necessarily refer to the same embodiment and are not mutually exclusive unless so stated. Specifically, a feature, structure, act, etc. described in one embodiment may also be included in other embodiments, but is not necessarily included. Thus, particular implementations of the present invention can include a variety of combinations and/or integrations of the embodiments described herein.

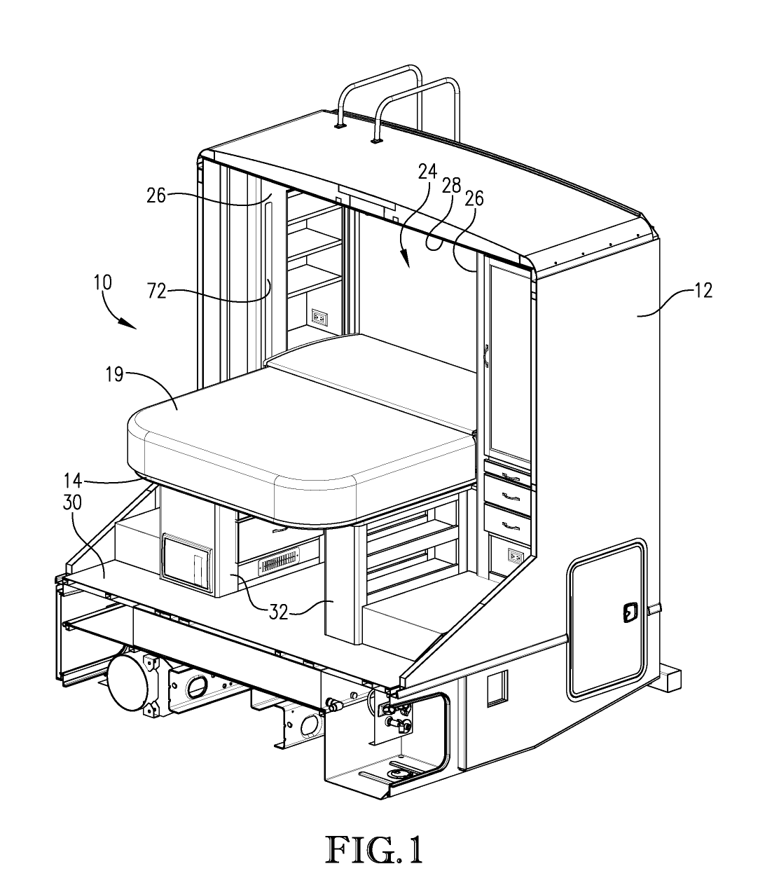

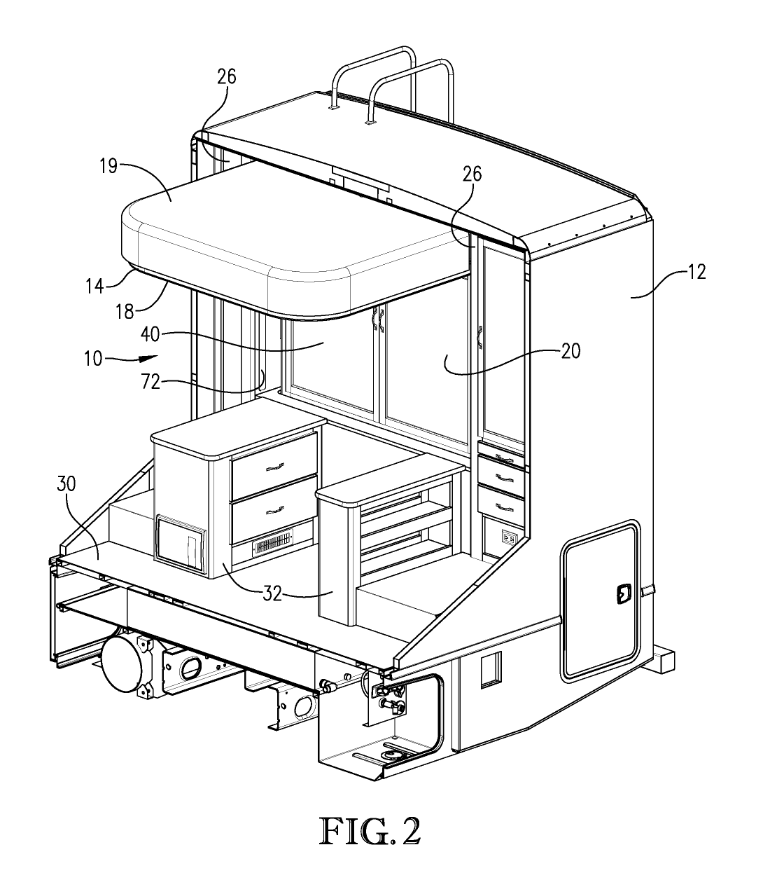

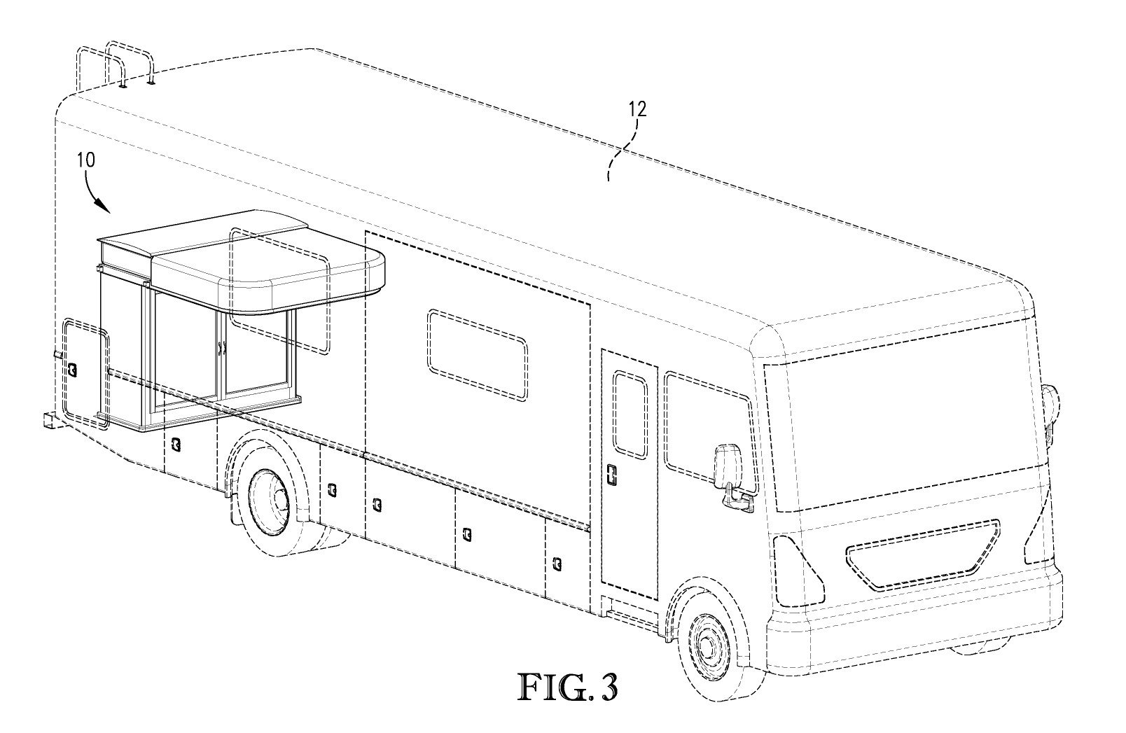

With reference to FIGS. 1-2, embodiments of the present invention are broadly directed to an adjustable bed assembly 10 for a vehicle 12. The vehicle 12 may include various types of recreational vehicles (RVs), such as campers, caravans, travel trailers, motor homes, or the like. For instance, FIG. 3 illustrates an exemplary vehicle 12 in the form of an RV. For clarity, however, the remaining figures simply illustrate a back end portion of the vehicle 12, with an interior of such back end portion including the bed assembly 10. Although embodiments of the present invention contemplate that the bed assembly 10 may be incorporated in the back end portion of the vehicle 12, it is understood that the bed assembly 10 can be positioned at other locations within the vehicle 12.

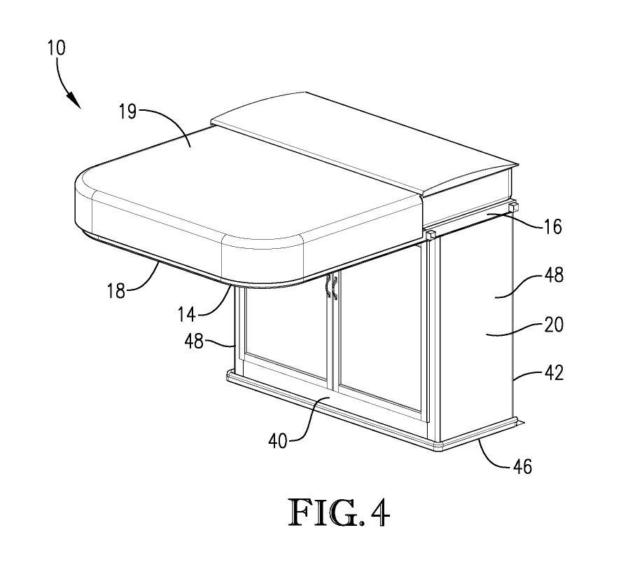

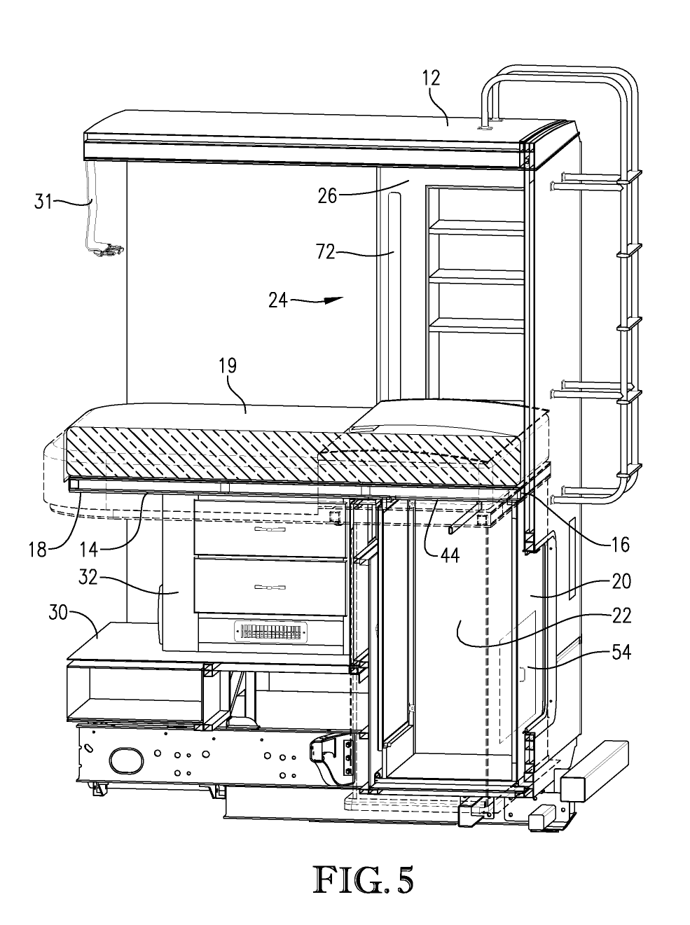

As perhaps best illustrated in FIGS. 4-5, the bed assembly 10 may broadly comprise a base platform 14 including a head portion 16 and a foot portion 18, with the base platform 14 configured to support a bed mattress 19. The bed assembly 10 may further comprise a storage housing 20 positioned underneath and extending below the head portion 16 of the base platform 14. As shown in FIG. 5, the storage housing 20 may include an interior, which presents a storage space 22. In some embodiments, the base platform 14 and the storage housing 20 may be securely coupled to one another, such that they are configured to actuate together, in unison. Specifically, as will be discussed in more detail below, the base platform 14 and the storage housing 20 may be selectively transitioned between a lowered configuration (See FIG. 1) and a raised configuration (See FIG. 2).

The bed assembly 10 may be generally situated within a living space of the vehicle 12. As used herein, the term living space is defined to mean an interior portion of the vehicle 12, with such interior portion enclosed by a body of the vehicle 12. As such, the living space can be used by occupants of the vehicle for performing living functions, such as eating, sleeping, working and the like. For instance, as illustrated in the drawings, the bed assembly 10 may be situated within the interior of the back end portion of the vehicle 12, with such interior of the back end portion comprising a bedroom of the vehicle 12. With the bed assembly 10 positioned within the bedroom of the vehicle 12, the bed assembly 10 can be used by vehicle 12 occupants for bedroom-related functions, such as sleeping, dressing, storing apparel, and the like.

Remaining with FIGS. 1-2, the base platform 14 of the bed assembly 10 may be a generally planar member operable to support the bed mattress 19. The bed mattress 19 can be any type of mattress that can be used by an occupant to rest, such as sitting down, lying down, and/or sleeping. In certain embodiments, the base platform 14 may be formed in a generally rectangular shape, having a top surface and a bottom surface, with the bed mattress 19 configured to be positioned on the top surface of the base platform 14, and with the storage housing 20 secured to the bottom surface of the base platform 14.

As perhaps best shown by FIGS. 1-2, with the bed assembly 10 positioned within the vehicle 12, such as positioned within a bedroom located within the back end portion of the vehicle 12, the head portion 16 of the base platform 14 may generally be positioned within a headspace area 24 defined by two side components 26 and by a ceiling 28 of the vehicle 12. In some embodiments, the two side components 26 may comprise furniture-type components of the vehicle 12, such as shelving, cabinets, closets or the like. For example, as shown in FIG. 1, one of the side components 26 may comprise a shelving unit with a number of shelves, while another of the side components 26 may comprise a closet and/or drawer unit. As such, the side components 26 may be configured to store personal articles, such as clothing, books, knick-knacks, or the like. In other embodiments, the side components 26 may simply comprise wall elements, paneling, or the like.

With the bed assembly 10 in the lowered configuration, as shown in FIG. 1, the head portion 16 of the base platform 14 may be positioned within a lower portion of the headspace area 24. As such, a significant remaining portion of the headspace area 24 is generally accessible from the living space of the vehicle 12. For example, an occupant of the vehicle 12 can access the headspace area 24 while sitting or lying on the mattress 19. Alternatively, with the bed assembly 10 in the raised configuration, as shown in FIG. 2, the head portion 16 of the base platform 14 is positioned within an upper portion of the headspace area 24, adjacent to the ceiling 28 of the vehicle 12. Furthermore, the storage housing 20 is also received within the remaining portions of the headspace area 24. As such, the headspace area 24 is generally inaccessible to an occupant of the vehicle 12.

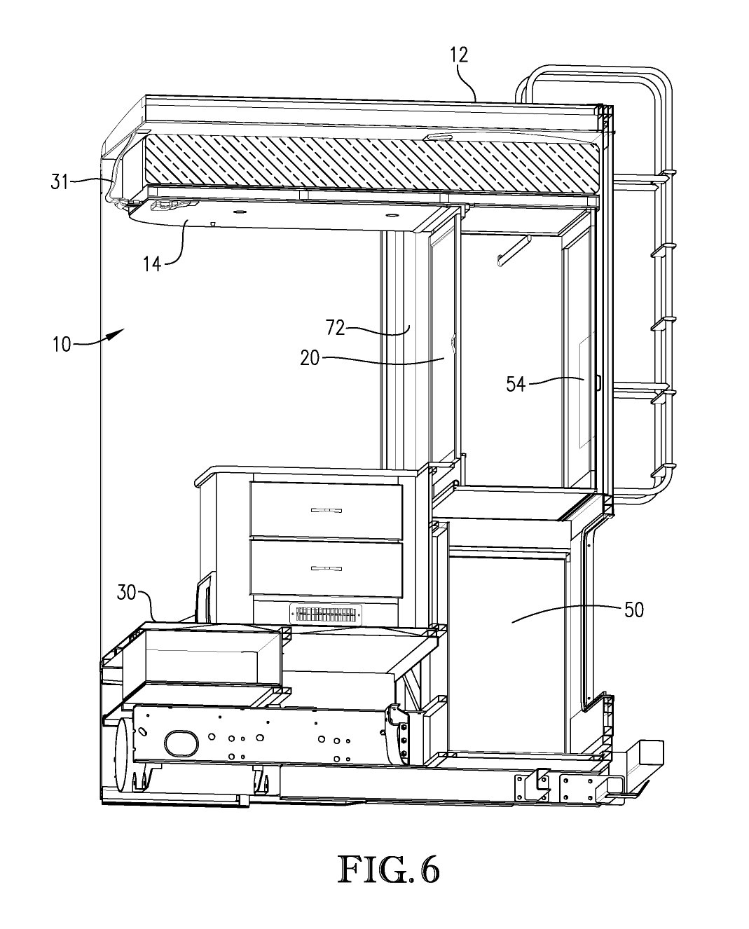

Remaining with the raised configuration of FIG. 2, the base platform 14 is generally positioned away from a floor 30 of the interior of the vehicle 12 and adjacent to (and/or in contact with) the ceiling 28 of the vehicle 12, with the top surface of the base platform 14 specifically positioned adjacent to the ceiling 28. In certain embodiments, the bed assembly 10 may include a securement mechanism for securing the base platform 14 to the ceiling 28 of the vehicle 12. For example, as shown in FIGS. 5-6, the securement mechanism may be in the form of a strap and buckle combination 31. In such embodiments, the straps of the strap and buckle combination 31 may be configured to extend from the ceiling 28 and wrap around at least a portion of the base platform 14 (including the bed mattress 19). For instance, as shown in FIG. 5, the strap extending from the ceiling 28 can be buckled with a buckle secure to the bottom surface of the base platform 14, so as to provide additional support for the base platform 14 when the bed assembly 10 is in the raised configuration. Other embodiments contemplate that securement mechanisms may comprise various additional mechanisms, such as one or more latch mechanisms, one or more fastener mechanisms, one or more hook and loop combinations, or the like, or combinations thereof.

In the lowered configuration (e.g., FIG. 1), the base platform 14 may be positioned away from the ceiling 28 of the vehicle 12 and closer towards the floor 30 of the vehicle 12. Nevertheless, the base platform 14 may be at least partially spaced apart from the floor 30, such as may be a preferred position for an occupant of the vehicle to use the bed assembly 10 for resting or sleeping. To accomplish such a preferred position, the base platform 14 may be supported on one or more floor supports 32, which may be configured to support the base platform 14 above the floor 30 of the vehicle 12. Specifically, the bottom surface of the base platform 14 may be positioned adjacent to (and/or in contact with) one or more floor supports 32. In some embodiments, the floor supports 32 may comprise cabinets, or other furniture-type components with drawers and/or shelves. As such, the floor supports 32 may be configured to store personal articles, such as clothing. In even further alternatives, the floor supports may simply comprise posts, pedestals, tables, chairs, benches, or the like.

Turning to the storage housing 20, and with reference to FIG. 4, some embodiments of the present invention may provide for the storage housing 20 to be shaped as a rectangular box having a front panel 40, a back panel 42, a top panel 44 (See FIG. 5), a bottom panel 46, and two side panels 48. Nevertheless, in other embodiments, the storage housing 20 may have other shapes. In some embodiments, the top panel 44 may be secured to a bottom surface of the base platform 14, so as to allow for the base platform 14 and the storage housing 20 to be actuated in unison. The top panel 44 may be secured to the base platform via one or more fastener arrangements (e.g., nut and bolt combinations), welds, adhesives, and/or combinations thereof. In still other embodiments, the base platform 14 may act as the top panel 44 of the storage housing 20, such that the front panel 40, back panel 42, and two side panels 48 are secured directly to the base platform 14.

As was previously-discussed, in the raised configuration of FIG. 2, the storage housing 20 may be positioned within the headspace area 24. Specifically, with the bed assembly 10 in the raised configuration, the headspace area 24 may be generally entirely filled with storage housing 20 and/or the base platform 14 (including the bed mattress 19). As illustrated in FIGS. 2 and 4, the front panel 40 of the storage housing 20 is configured to face towards the foot portion 18 of the base platform 14. As such, the front panel 40 is configured to face towards the living space of the vehicle 12 when the bed assembly 10 is in the raised configuration. In some embodiments, the front panel 40 may include one or more access doors for providing access to the storage space 22 of the storage housing 20. As such, an occupant of the vehicle 12 can access the storage space 22 from the interior living space of the vehicle 12. As illustrated in FIG. 2, an occupant can access the storage housing 20 to place or retrieve personal articles, such as clothing or other articles, within the storage space 22. For example, as shown in FIGS. 5-7, some embodiments provide for the storage housing 20 to include a hanger rod extending through a portion of the storage space 22 for hanging shirts, jackets, pants, or the like. In other embodiments, the storage housing 20 may include other components for facilitating the storage of clothing, such as one or more shelving units, drawers, or the like, all included within the storage space 22. In further embodiments, articles can be stored within the storage space 22 on the bottom panel 46 of the storage housing 20. For example, shoes may be stored on the bottom panel 46 of the storage housing 20.

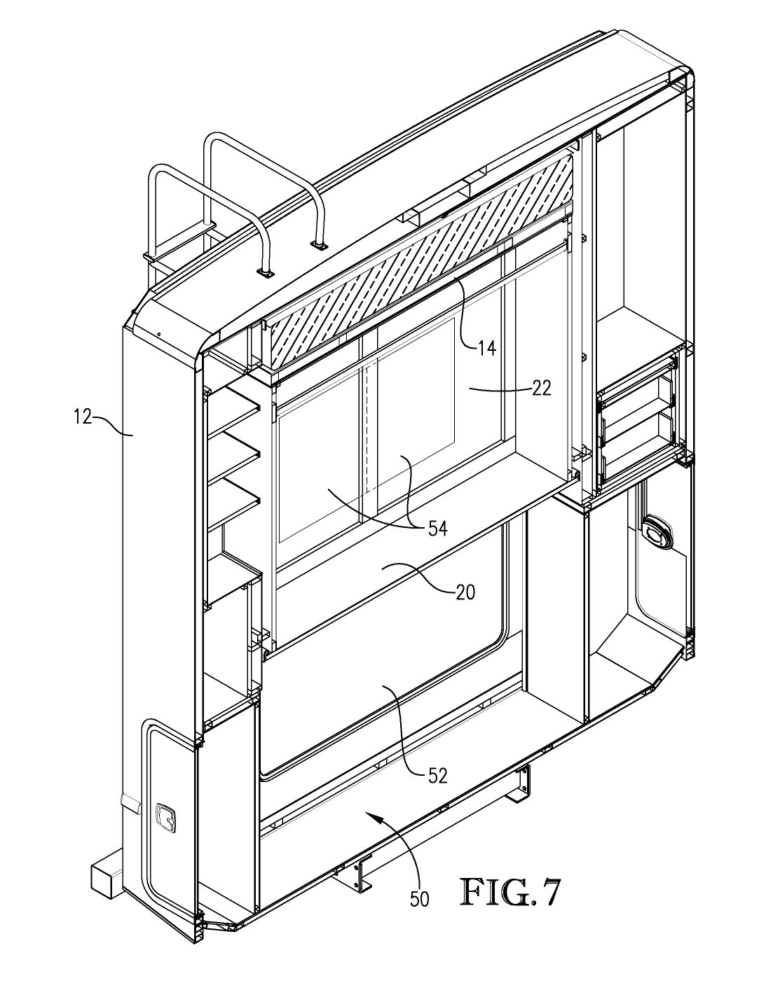

As illustrated in FIGS. 6-7, embodiments of the present invention further provide for the vehicle 12 to comprise a storage housing receiving area 50 located generally below the headspace area 24. In certain embodiments, at least a portion of the storage housing receiving area 50 is generally positioned below the floor 30 of the vehicle 12. As such, the storage housing receiving area 50 is generally inaccessible from the living space of the vehicle 12.

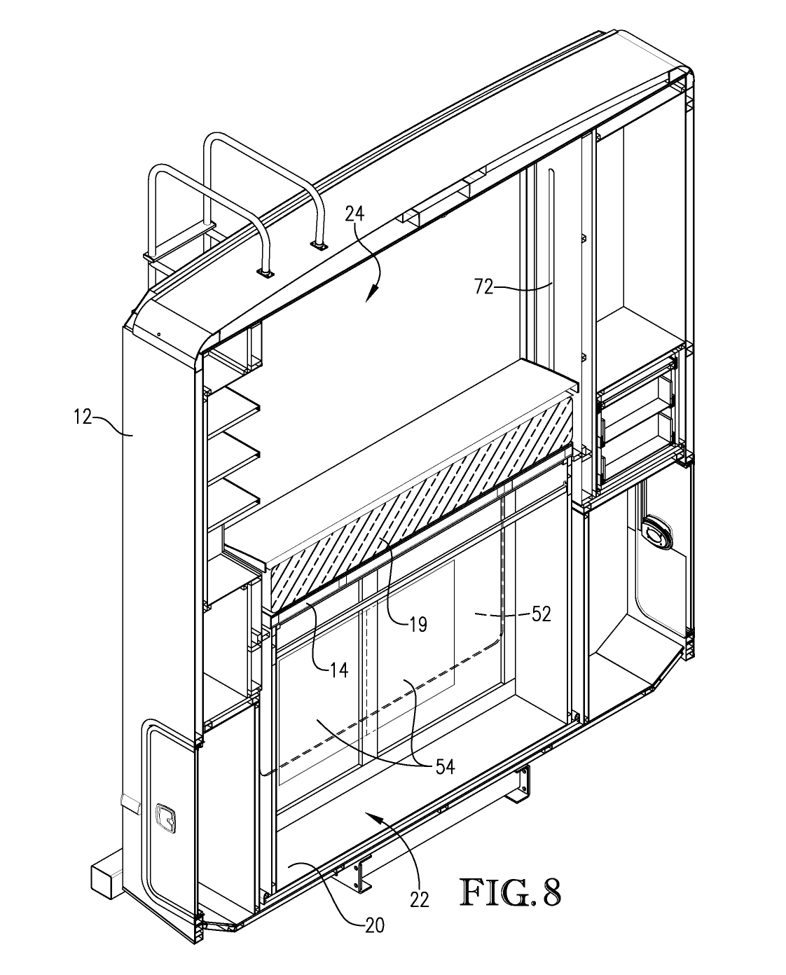

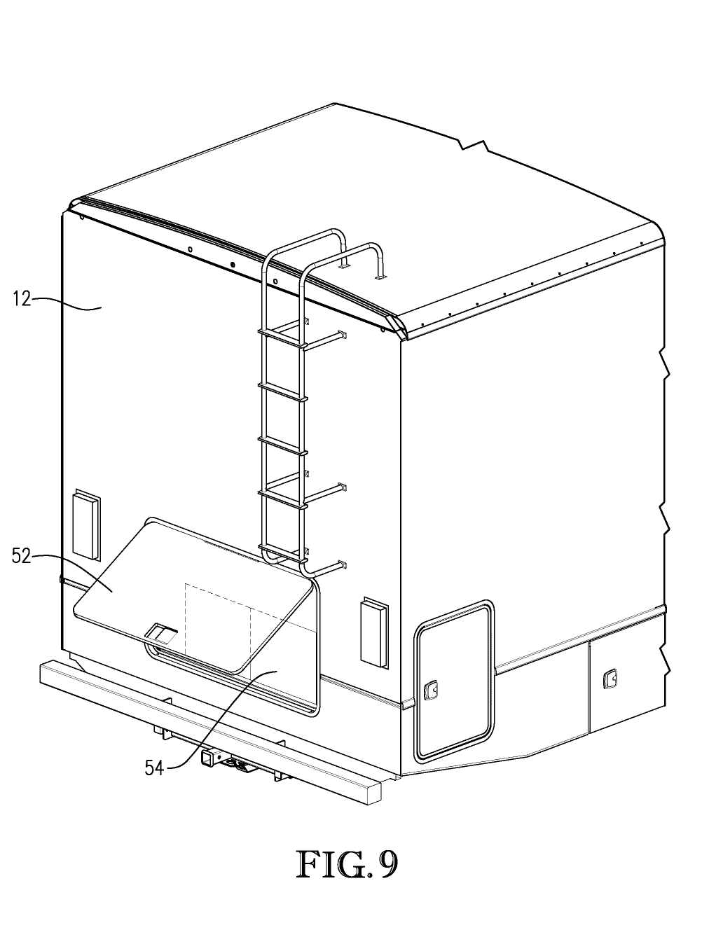

In the lowered configuration (i.e., FIGS. 1, 5, and 8), the storage housing 20 may be positioned generally within the storage housing receiving area 50. In some embodiments, the storage housing 20 may fill generally the entirety of the storage housing receiving area 50 when the bed assembly 10 is in the lowered configuration. In some embodiments, as shown in FIG. 9, a back end of the vehicle 12 may include an access door 52, for accessing the storage housing receiving area 50 from the exterior of the vehicle 12. In further embodiments, as illustrated in FIG. 8, the back panel 42 of the storage housing 20 may include an access opening 54. In some embodiments, the access opening 54 may be or may be associated with one or more access doors. In even further alternative embodiments, the access opening 54 may simply comprise the back panel 42 of the storage housing 20 being removed, such that the storage housing 20 does not include the back panel 42. Regardless, in the lowered configuration of the bed assembly 10, with the storage housing 20 in the storage housing receiving area 50, the storage space 22 within the storage housing 20 may be accessible from an exterior of the vehicle 12 via the access door 52 of the back end of the vehicle 12 and from the access opening 54 of the back panel 42 of the storage housing 20.

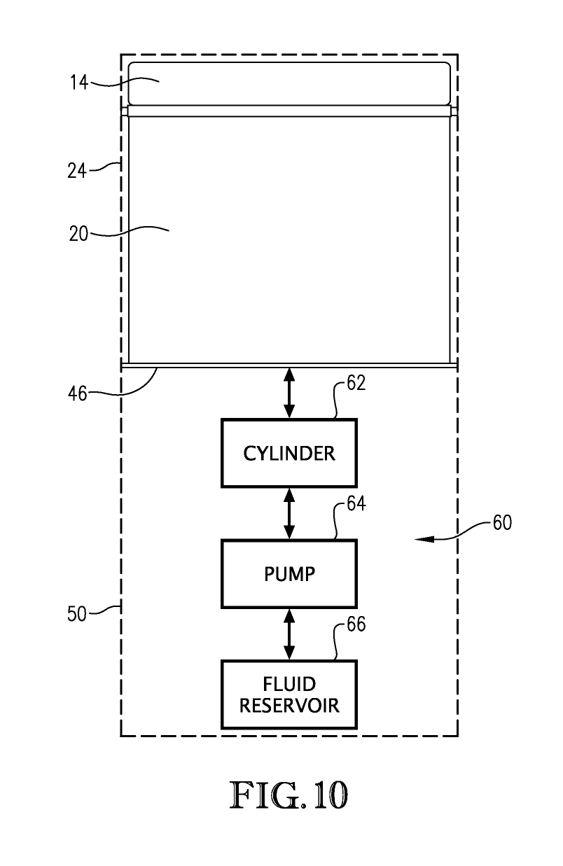

Embodiments of the present invention provide for the base platform 14 and the storage housing 20 to be shiftable between the lowered configuration and the raised configuration by a lifting system. Embodiments contemplate that the lifting systems may comprise various types of systems capable of performing lifting operations, such as hydraulic systems, pneumatic systems, electromechanical systems, or combinations thereof. For example, as illustrated in FIG. 10, in some specific embodiments, the lifting mechanism may comprise a hydraulic system 60, with such hydraulic system 60 including a hydraulic cylinder 62, a hydraulic pump 64, a fluid reservoir 66, and other components generally associated with a hydraulic system (e.g., valves, fluid lines, etc.). One or more portions of the hydraulic system 60, such as the hydraulic cylinder 62, may be positioned within a portion of the storage housing receiving area 50. As such, a portion of the hydraulic cylinder 62, such as a hydraulic piston, may be configured to engage with the bottom panel 46 of the storage housing 20 to raise and lower the main platform 14 and the storage housing 20 of the bed assembly 10.

Specifically, with the bed assembly 10 in the lowered configuration, the hydraulic fluid can be supplied to the hydraulic cylinder 62 from the fluid reservoir 66, under power from the pump 64 from the fluid reservoir 66, such that the hydraulic cylinder 62 can raise the storage housing 20 from within the storage housing receiving area 50 and into the headspace area 24. Furthermore, hydraulic fluid can be removed from the hydraulic cylinder 62, such that the storage housing 20 can be lowered from the headspace area 24 and back into the storage housing receiving area 50. It should also be understood that because the storage housing 20 is coupled with the base platform 14, the hydraulic system 60 is configured to raise and lower the base platform 14 (and the bed mattress 19) along with the storage housing 20. In some embodiments, the hydraulic system 60 may include a plurality of hydraulic cylinders 62 for facilitating the raising and lowering of the base platform 14 and the storage housing 20 of the bed assembly 10.

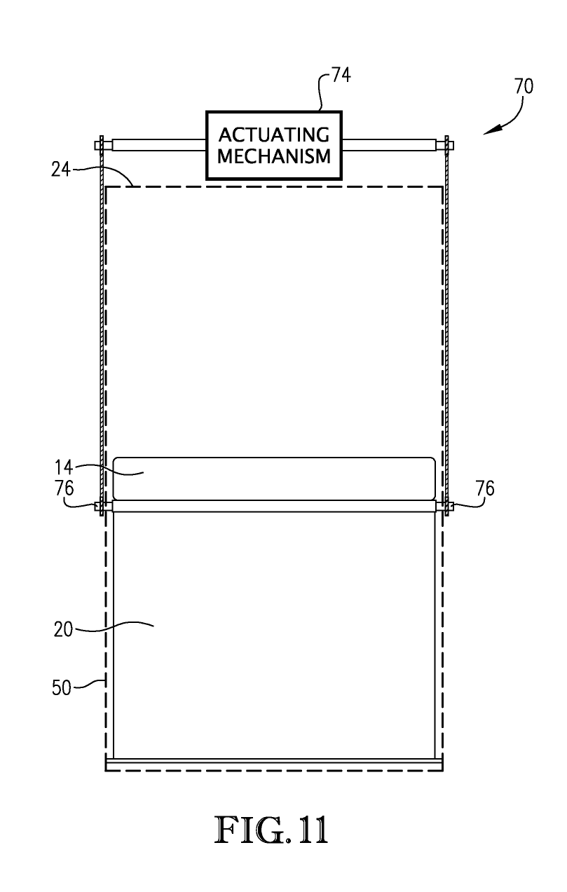

In some additional embodiments, such as illustrated in FIG. 11, the lifting mechanism may comprise an electromechanical system 70. The electromechanical system 70 may include one or more tracks 72, such as shown in FIGS. 1, 2, 5, 6, and 8, which may be associated with one or more of the first and second side components 26. The electromechanical system 70 may also include one or more actuating mechanism 74, as illustrated in FIG. 11, which may be positioned within the side components 26 and associated with the tracks 72. The actuating mechanism 74 may be configured to actuate the base platform 14 and the storage housing 20, so as to transition the bed assembly 10 from the lowered configuration to the raised configuration (and vice versa).

In more detail, and with continued reference to FIG. 11, the base platform 14 may include one or more guide blocks 76, which extend from its sides lateral sides. The guide blocks 76 may be configured to be received within the tracks 72 of the side components 26 for engagement with the actuating mechanism 74. As such, the actuating mechanism 74 is capable of raising and lowering the base platform 14 and the storage housing 20 by actuating the guide blocks 74 upwards and downwards. In certain embodiments, the actuating mechanism 72 may comprise a rack and pinion assembly, a chain and gear assembly, a belt-drive assembly, a winch and pulley assembly, or the like or combinations thereof. In some embodiments, the actuating mechanism 74 may be powered by the motor of the vehicle 12. It is contemplated that the tracks 72 of the side component 26 and the guide blocks 76 of the main platform 14 may be used with other types of lifting mechanisms (e.g., the hydraulic mechanism 60) as a guide mechanism to maintain the correct positioning and alignment of the bed assembly 10 during use of the bed assembly 10 and during transitions from the lowered configuration to the raised configuration (and vice versa).

In operation, the bed assembly 10 is configured to be selectively raised and lowered from the lowered configuration (e.g., FIG. 1) to the raised configuration (e.g., FIG. 2). In the lowered configuration, the base platform 14 (and an associated bed mattress 19) may be positioned near the floor 30 of the vehicle 12 and the storage housing 20 may be received within the storage housing receiving area 50. In such a configuration, an occupant of the vehicle 12 can access the base platform 14 from the living area of the vehicle 12 for purposes of resting, sitting, sleeping, or the like. Additionally, the headspace area 24 is accessible from the living space of the vehicle 12. In particular, in embodiments in which the side component 26 include shelves, cubby-holes, or the like, the occupants of the vehicle can access the headspace area 24, including the side components 26, for purposes of storing or retrieving personal items to/from the side components 26. Furthermore, although while in the lowered position the storage space 22 of the storage housing 20 is not accessible form the living space of the vehicle 12, certain embodiments may provide for the storage space 22 to be accessible from the exterior of the vehicle 12. As previously described, certain embodiments provide for the back end of the vehicle 12 to include the access door 52 for accessing the storage housing receiving area 50. Additionally, some embodiments provide for the back panel 42 of the storage housing 20 to include the access opening 54 (e.g., an access door). As such, occupants of the vehicle 12 can access the storage space 22 of the storage housing 20 by accessing such access doors and/or openings from the exterior of the vehicle 12. In particular, the occupants can load and/or unload articles, such as clothing, to and/or from the storage space 22.

Alternatively, if the occupants of the vehicle 12 do not have a present need for the base platform 14 and its associated bed mattress 19, the occupant can select to raise the base platform 14 and the storage housing 20 to the raised configuration, as illustrated in FIG. 2. As previously described, in the raised configuration, the base platform 14 is positioned adjacent to the ceiling 28 of the vehicle, and the storage housing 20 is raised into the headspace area 24. Once raised, certain embodiments provide for the vehicle 12 occupant to secure the base platform 14 to the ceiling 28 via the securement mechanism, as previously described. In such a raised configuration, the occupant has access to an expanded amount of living space within the vehicle 12. In particular, the space immediately underneath the raised base platform 14 is available for use by the occupants. Furthermore, the occupants can access the storage space 22 presented by the storage housing 20 for retrieving or storing personal articles, such as clothing. In additional embodiments, if the floor supports 32 include shelves, cubby-holes, or the like, the occupants can access such for retrieving or storing personal articles. It should also be noted that in the raised configuration, the storage housing receiving area 50 will not contain the storage housing 20. As such, the occupants may access the storage housing receiving area 50 via the access door 52 on the back end of the vehicle 12 for storing items within the storage housing receiving area 50. It is further understood, however, that such items may be required to be removed from the storage housing receiving area 50 before the storage housing 20 is lowered back into the storage housing receiving area 50.

The bed assembly 10 may include various types of control system for controlling the position of the bed assembly 10 and/or for transitioning the bed assembly 10 from the lowered configuration to the raised configuration. For example, the control system may include a control panel with electromechanical switches, dials, knobs, or the like, which are in communication with the lifting system. As such, the occupant of vehicle 12 can control the position of the bed assembly 12 by manipulating the control panel. Embodiments may provide for the control panel to be positioned within the interior of the vehicle 12, such as on a wall of the bedroom in the back portion of the vehicle 12. Alternatively, embodiments may provide for the control panel to be positioned on an exterior of the vehicle 12, such as on the back end of the vehicle 12, such that the occupant can control the position of the bed assembly 10 from an exterior of the vehicle 12. In still other embodiments, the control system may be wireless, such that an occupant can control the position of the bed assembly from a key fob, a computing device (e.g., smartphone), or the like.

Although the invention has been described with reference to one or more embodiments illustrated in the figures, it is understood that equivalents may be employed and substitutions made herein without departing from the scope of the invention as recited in the claims.

Having thus described one or more embodiments of the invention, what is claimed as new and desired to be protected by Letters Patent includes the following:

1. An adjustable bed assembly for a vehicle, the bed assembly comprising:
a base platform comprising a head portion and a foot portion, wherein said base platform is configured to support a bed mattress; and
a storage housing positioned underneath the head portion of said base platform and presenting a storage space within said storage housing,
wherein said base platform and said storage housing are coupled together, so as to actuate in unison between a raised configuration and a lowered configuration.

2. The adjustable bed assembly of claim 1, wherein said base platform is generally planar and formed in rectangular shape presenting a top surface and a bottom surface, and wherein said storage housing is coupled to the bottom surface of said base platform.

3. The adjustable bed assembly of claim 1, further comprising two spaced apart side components presenting a headspace area between said side components, wherein the head portion of said base platform is positioned within said headspace area, and wherein said headspace area is bounded by a ceiling of the vehicle.

4. The adjustable bed assembly of claim 3, wherein with said bed assembly in the lowered configuration, the head portion of said base platform is positioned within a bottom portion of the headspace area.

5. The adjustable bed assembly of claim 3, wherein with said bed assembly in the raised configuration, the head portion of said base platform is positioned within an upper portion of the headspace area and adjacent to the ceiling of the vehicle.

6. The adjustable bed assembly of claim 1, wherein in the lowered configuration of said bed assembly, said base platform is supported on one or more floor supports that support said base platform from a floor of the vehicle.

7. The adjustable bed assembly of claim 6, wherein said floor supports comprise cabinets configured to store personal articles.

8. The adjustable bed assembly of claim 1, wherein said storage housing is shaped as a rectangular box comprising a front panel, a back panel, a bottom panel, and two side panels, with the front panel facing towards the foot section of said base platform.

9. The adjustable bed assembly of claim 8, wherein said front panel includes one or more access doors for providing access to the storage space within said storage housing.

10. The adjustable bed assembly of claim 3, wherein in the raised configuration, said storage housing is positioned within the headspace area.

11. The adjustable bed assembly of claim 3, wherein said bed assembly further comprises a storage housing receiving area located generally below the headspace area, wherein at least a portion of the storage housing receiving area is generally positioned below a floor of the vehicle.

12. The adjustable bed assembly of claim 11, wherein in the lowered configuration, said storage housing is positioned within the storage housing receiving area.

13. A vehicle with an adjustable bed assembly, wherein said vehicle comprises:
a vehicle body enclosing a living space within said vehicle;
said adjustable bed assembly, with said adjustable bed assembly comprising
a base platform including a head portion and a foot portion, wherein said base platform is configured to support a bed mattress,
a storage housing positioned underneath said head portion of said base platform and presenting a storage space within said storage housing, and
wherein said base platform and said storage housing are coupled together, so as to actuate in unison between a raised configuration and a lowered configuration; and
first and second side components spaced apart to define a headspace area, wherein the headspace area is bounded by a ceiling of said vehicle, wherein said head portion of said base platform is received within the headspace area,
wherein said vehicle further includes a storage housing receiving area located generally below the headspace area, wherein at least a portion of the storage housing receiving area is positioned below a floor of said vehicle,
wherein in the raised configuration, said base platform and said storage housing are positioned within the headspace area of said vehicle, such that the storage space is accessible from the living space of said vehicle,
wherein in the lowered configuration, said storage housing is received in the storage housing receiving area, such that the storage space is not accessible from the living space of said vehicle.

14. The vehicle of claim 13, wherein a back end of said vehicle includes an access door for accessing the storage housing receiving area.

15. The vehicle of claim 14, wherein a back side of the storage housing includes an access door, such that wherein in the lowered configuration, with said storage housing received in the storage housing receiving area, the storage space is accessible from an exterior of said vehicle via said access doors of the back end of said vehicle and via said access door of said back side of said storage housing.

16. The vehicle of claim 13, wherein said base platform and said storage housing are shiftable between the lowered configuration and the raised configuration by a lifting mechanism.

17. The vehicle of claim 16, wherein said lifting mechanism comprises a hydraulic system configured to engage a bottom side panel of said storage housing to shift said base platform and said storage housing.

18. A method of operating an adjustable bed assembly for a vehicle, with the bed assembly comprising a base platform configured to support a bed mattress and a storage housing coupled with the base platform and positioned underneath the base platform, wherein the storage housing presents a storage space within the storage housing, the method comprises the steps of:
(a) shifting the bed assembly from a lowered configuration to a raised configuration,
wherein in the raised configuration, the base platform is positioned adjacent to a ceiling of the vehicle and the storage space is accessible from an interior of the vehicle; and
(b) actuating the bed assembly from the raised configuration to the lowered configuration,
wherein in the lowered configuration, the base platform is positioned adjacent to a floor of the vehicle and the storage space is not accessible from the interior of the vehicle,
wherein the base platform and the storage housing are configured to actuate in unison.

19. The method of claim 18, wherein in the lowered configuration, the storage housing is positioned within a storage housing receiving area of the vehicle, wherein such storage housing receiving area is located below a floor of the vehicle.

20. The method of claim 19, wherein in the lowered configuration, the storage space is accessible from an exterior of the vehicle.
